(19) United States
(12) Patent Application Publication
(10) Pub. No.: US 2024/0331279 A1
(43) Pub. Date: Oct. 3, 2024

(54) SYSTEM AND METHOD FOR COMPLETING THREE DIMENSIONAL FACE RECONSTRUCTION

(71) Applicant: Honda Motor Co., Ltd., Tokyo (JP)

(72) Inventors: Kunal NANDANWAR, Worcester, MA (US); Nawid JAMALI, San Francisco, CA (US); Hifza JAVED, San Jose, CA (US)

(21) Appl. No.: 18/194,793

(22) Filed: Apr. 3, 2023

(51) Int. Cl. G06T 17/00; G06V 40/16

(52) U.S. Cl. CPC G06T 17/00; G06V 40/168

(57) ABSTRACT

A system and method for completing three dimensional face reconstruction that includes receiving image data associated with multiple two dimensional non-frontal face images. The system and method also includes analyzing the image data and extracting two dimensional facial features. The system and method additionally includes constructing sparse three dimensional facial feature point clouds based on the two dimensional facial features. The system and method further includes inputting the sparse three dimensional facial feature point clouds into an encoder-decoder architecture to generate a three dimensional facial feature point cloud of complete facial features.

### BACKGROUND

There has been some research completed in the area of image face construction. Researchers have proposed some architectures that may be used to analyze front captured facial images with two dimensional images. However, these architectures fail to show visually accurate results when images contain non-front facing faces and/or faces that are occluded by a person or object. Accordingly, if a person's face is not captured from a camera that is directly facing the front of a person's face or a person's face is occluded within one or more images, an accurate construction of the person's face may not be determined to be further analyzed.

### BRIEF DESCRIPTION

According to one aspect, a computer-implemented method for completing three dimensional face reconstruction. The computer-implemented method includes receiving image data associated with multiple two dimensional non-frontal face images. The computer-implemented method also includes analyzing the image data and extracting two dimensional facial features. The computer-implemented method additionally includes constructing sparse three dimensional facial feature point clouds based on the two dimensional facial features. The computer-implemented method further includes inputting the sparse three dimensional facial feature point clouds into an encoder-decoder architecture to generate a three dimensional facial feature point cloud of complete facial features. The three dimensional facial feature point cloud is utilized to control a computing device to complete a downstream task.

According to another aspect, a system for completing three dimensional face reconstruction. The system includes a memory storing instructions that are executed by a processor. The instructions include receiving image data associated with multiple two dimensional non-frontal face images. The instructions also include analyzing the image data and extracting two dimensional facial features. The instructions additionally include constructing sparse three dimensional facial feature point clouds based on the two dimensional facial features. The instructions further include inputting the sparse three dimensional facial feature point clouds into an encoder-decoder architecture to generate a three dimensional facial feature point cloud of complete facial features. The three dimensional facial feature point cloud is utilized to control a computing device to complete a downstream task.

According to yet another aspect, a non-transitory computer readable storage medium storing instructions that when executed by a computer, which includes a processor performs a method. The method includes receiving image data associated with multiple two dimensional non-frontal face images. The method also includes analyzing the image data and extracting two dimensional facial features. The method additionally includes constructing sparse three dimensional facial feature point clouds based on the two dimensional facial features. The method further includes inputting the sparse three dimensional facial feature point clouds into an encoder-decoder architecture to generate a three dimensional facial feature point cloud of complete facial features. The three dimensional facial feature point cloud is utilized to control a computing device to complete a downstream task.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary system for completing three dimensional face reconstruction according to an exemplary embodiment of the present disclosure;

FIG. 2 is an illustrative example of an external environment in which three dimensional face reconstruction is computed according to an exemplary embodiment of the present disclosure;

FIG. 3 is a process flow diagram of a method for generating a three dimensional face reconstruction of an individual's face according to an exemplary embodiment of the present disclosure;

FIG. 4 is a framework for reconstructing a three dimensional facial feature point cloud from multiple non-overlapping images; and

FIG. 5 is a process flow diagram of a method for completing three dimensional face reconstruction according to an exemplary embodiment of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk”, as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “memory”, as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

A “module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discreet logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection”, or a connection by which entities are “operably connected”, is one in which signals, physical communications, and/or logical communications may be sent and/or received. An operable connection may include a wireless interface, a physical interface, a data interface and/or an electrical interface.

A “processor”, as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “vehicle”, as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) that is capable of carrying one or more human occupants and is powered entirely or partially by one or more electric motors powered by an electric battery. The EV may include battery electric vehicles (BEV) and plug-in hybrid electric vehicles (PHEV). The term “vehicle” may also refer to an autonomous vehicle and/or self-driving vehicle powered by any form of energy. The autonomous vehicle may or may not carry one or more human occupants. Further, the term “vehicle” may include vehicles that are automated or non-automated with pre-determined paths or free-moving vehicles.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

### I. System Overview

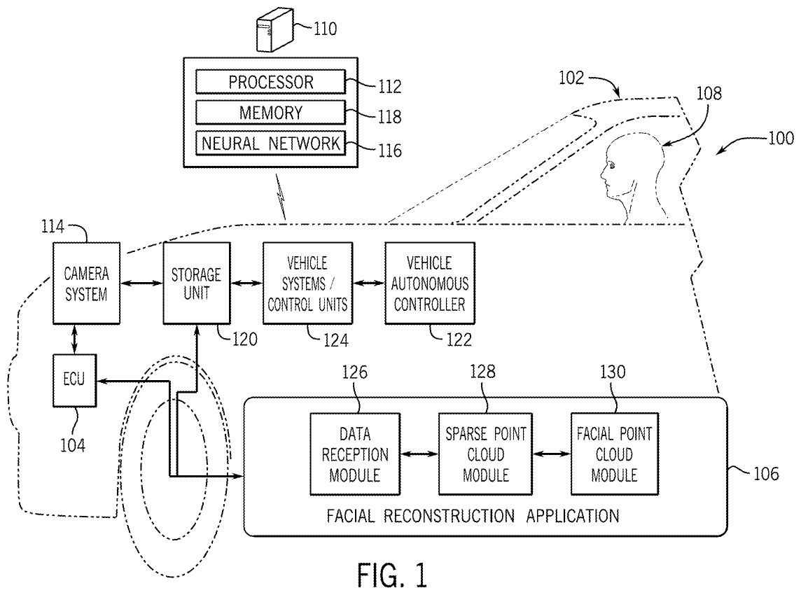

Referring now to the drawings, wherein the showings are for purposes of illustrating one or more exemplary embodiments and not for purposes of limiting same, FIG. 1 is a schematic view of an exemplary system 100 for completing three dimensional face reconstruction according to an exemplary embodiment of the present disclosure. The components of the system 100, as well as the components of other systems, hardware architectures, and software architectures discussed herein, may be combined, omitted, or organized into different architectures for various embodiments.

In one embodiment, the system 100 may include a vehicle 102 that includes an electronic control unit (ECU) 104 that executes one or more applications, operating systems, vehicle system and subsystem user interfaces, among others. The ECU 104 may also execute a facial reconstruction application 106 that may be configured to complete three dimensional face reconstruction based on non-frontal or occluded facial images of an individual 108 that may be an occupant of the vehicle 102.

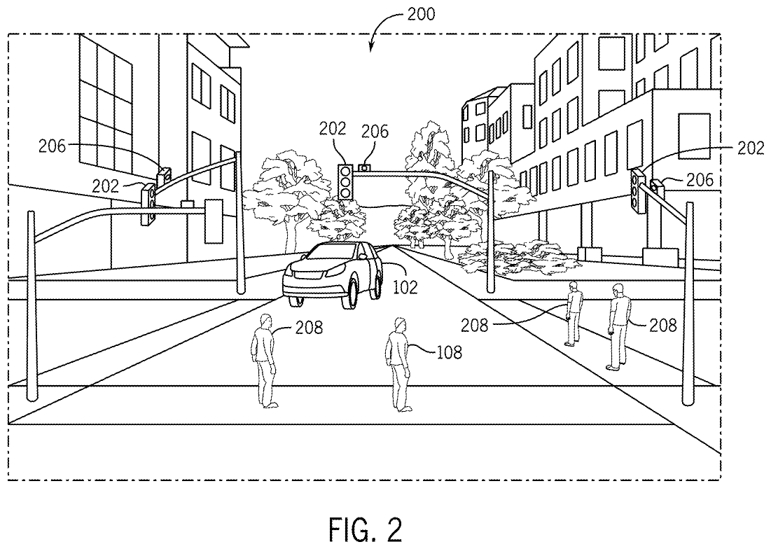

In an alternate embodiment, an external server computing infrastructure 110 of the system 100 may be configured to include a processor 112 that executes one or more applications, operating systems, vehicle system and subsystem user interfaces, among others. The processor 112 may be configured to execute a facial reconstruction application 106 that may be configured to complete three dimensional face reconstruction based on non-frontal or occluded facial images of one or more individuals that may be located in non-vehicular environments. As shown in FIG. 2, the facial reconstruction application 106 may additionally or alternatively be configured to complete three dimensional face reconstruction based on non-frontal or occluded facial images of the individual 108 that may be a pedestrian 208 that may be traveling within an external environment 200.

It is to be appreciated that the facial reconstruction application 106 may be configured to complete three dimensional face reconstruction based on non-frontal or occluded facial images of one or more individuals that may be located in various types of environments in addition to the vehicular environment or the external environment represented in FIG. 1 and FIG. 2 and that such individuals may be involved in various types of activities (e.g., communicating amongst one another, interacting with a robotic application, participating in particular activities, etc.). However, for the purposes of simplicity, this disclosure will mainly describe the execution of the facial reconstruction application 106 with respect to the vehicular environment of FIG. 1 and/or the external environment 200 of FIG. 2.

With continued reference to FIG. 1 and FIG. 2, the facial reconstruction application 106 may be configured to reconstruct a three-dimensional facial feature point cloud from multiple non-overlapping images of the individual 108 and/or one or more additional individuals that may be captured by cameras (not shown) of a camera system 114. The cameras of the camera system 114 may be included as part of the vehicle 102.

With respect to the vehicle 102, shown in FIG. 1, the cameras may be located within interior portions of an interior cabin of the vehicle 102 and may be configured to capture views of the individual 108 and/or one or more additional occupants (not shown) of the vehicle 102. In some configurations, the cameras may not be located directly in front of the individual 108 and/or the additional occupants and therefore may not necessarily capture frontal views of the individual's and/or occupants' face(s). In one or more embodiments, the images captured by respective cameras may include two dimensional images of side views of the individual's face. Accordingly, one or more cameras may capture one or more two dimensional images of a left side of the individual's face and one or more cameras may capture one or more two dimensional images of a right side of the individual's face within the vehicle 102.

With respect to the external environment 200 shown in FIG. 2, the cameras may be disposed upon each RSE 202 and may be configured to capture views of the individual 108 and/or pedestrians 204 that may be traveling within the external environment 200. The cameras may not be located directly in front of the individual 108 and/or the pedestrians 204 and therefore may not necessarily capture frontal views of the faces of the individual 108 and/or the pedestrians 208. The images captured by respective cameras may include two dimensional images of a side view of the individual's face. Accordingly, one or more cameras may capture one or more two dimensional images of a left side of the individual's face and one or more cameras may capture one or more two dimensional images of a right side of the individual's face as they are traveling within the external environment 200.

In both the vehicular environment and/or the external environment 200, the left-view and the right-view images of the face of interest of the individual 108 may be captured at different angles with respect to a plane of each respective lens (not shown) of each camera. These two-dimensional images may capture certain facial features that may pertain to distinguishing elements of the individual's face, that may include, but may not be limited to, an eye, nose, lips, etc.

In some cases, self-occlusions which may include occlusions to the image of the right and/or left side of the individual's face may also take place that may be caused by the individual themselves or by an object appearing in front of the individual's face. For example, one or more right side facial features may not be visible from a left side of the image due to self-occlusion that may be caused by an individual raising their arm in between a lens of a respective camera and the right side of their face. Additionally, one or more left side facial features may not be visible from a right side of the image due to another vehicle that may be located in between a lens of a respective camera 206 and the individual 108 within the external environment 200. Accordingly, the two dimensional images may not include a full frontal or non-occluded view of the face of the respective individual 108.

In an exemplary embodiment, the facial reconstruction application 106 may be configured to complete a three dimensional shape reconstruction of the face of the respective individual 108 based on two or more two dimensional images of the individual's face as captured by respective cameras. As such, the facial reconstruction application 106 may be configured to complete a three dimensional shape reconstruction of the face of the respective individual 108 if the two dimensional images of the individual's face do not include a front facial image of the individual's face. Additionally, the facial reconstruction application 106 may be configured to complete a three dimensional shape reconstruction of the face of the respective individual 108 if the two dimensional images of the individual's face include self-occlusions that may be caused by an object or due to the individual themselves.

As discussed in more detail below, the facial reconstruction application 106 may be configured to access a neural network 116 that may be stored upon a memory 118 of the external server 110. The facial reconstruction application 106 may be configured to utilize the neural network 116 to construct a three dimensional facial point cloud from multiple non-frontal and/or self-occluded images of the individual 108. Upon constructing the three dimensional facial point cloud, the facial reconstruction application 106 may be configured to utilize one or more datasets (not shown) to analyze the three dimensional facial point cloud of the individual's face to send one or more commands to one or more computing systems to control one or more electronic components based on the individual's facial expressions. For example, the facial reconstruction application 106 may be configured to utilize one or more datasets to analyze the three dimensional facial point cloud of the individual's face to be used in a variety of applications, such as human emotion estimation (anger, disgust, feat, happiness, sadness, surprise, neutral, etc.), human satisfaction level estimation (for example, range 1-10, 1 being the lowest and 10 being the highest), relational affect estimation (positive, negative, neutral, etc.), etc.

The present disclosure accordingly describes a system and method that allows an improvement to the technology with respect to the construction of a three dimensional facial features of an individual 108 from multiple non-overlapping images that may not necessarily contain a non-occluded frontal view of the individual's face. Accordingly, the present disclosure provides an improvement in the technology of three dimensional facial feature reconstruction that are based on two dimensional images of a human face that include side images without capturing an image of a frontal face that may be utilized to control a computing system to complete one or more downstream tasks.

With continued reference to FIG. 1, the ECU 104 may be configured to be operably connected to a plurality of additional components of the vehicle 102, including the camera system 114, a storage unit 120, a vehicle autonomous controller 122, and vehicle systems/control units 124 of the vehicle 102. In one or more embodiments, the ECU 104 may include a microprocessor, one or more application-specific integrated circuit(s) (ASIC), or other similar devices. The ECU 104 may also include internal processing memory, an interface circuit, and bus lines for transferring data, sending commands, and communicating with the plurality of components of the vehicle 102.

The ECU 104 may also include a communication device (not shown) for sending data internally within (e.g., between one or more components) the vehicle 102 and communicating with externally hosted computing systems (e.g., external to the vehicle 102). Generally, the ECU 104 may communicate with the storage unit 120 to execute the one or more applications, operating systems, vehicle system and subsystem user interfaces, and the like that are stored within the storage unit 120.

In one or more embodiments, the three dimensional facial feature reconstruction determined by the facial reconstruction application 106 may be analyzed to complete one or more downstream tasks. In one configuration, downstream tasks associated with providing of alerts, audio output, or graphical output within the vehicle 102 may be completed based on the three dimensional facial feature reconstruction. In another configuration, commands may be executed to autonomously or semi-autonomously control the vehicle 102 to be operated in a specific manner based on the three dimensional facial feature reconstruction. For example, the three dimensional facial feature reconstruction may be analyzed to determine driver facial expressions that may be associated with fatigue, surprise, boredom, etc. to provide alerts, audio output, graphical output, and/or autonomous control with respect to the vehicle 102.

In one embodiment, such commands may be sent from the ECU 104 to the vehicle autonomous controller 122 to provide alerts, audio output, or graphical output within the vehicle 102 and/or to provide autonomous driving commands to operate the vehicle 102 to be fully autonomously driven or semi-autonomously driven in a particular manner. In one configuration, the vehicle autonomous controller 122 may be configured to output commands to one or more of the vehicle systems/control units 124 to provide alerts, audio output, or graphical output within the vehicle 102 that may be based on driver facial expressions derived from the determined three dimensional facial feature reconstruction.

The vehicle autonomous controller 122 may also be configured to execute autonomous driving commands to operate the vehicle 102 to be fully autonomously driven or semi-autonomously driven in a particular manner. The autonomous driving commands may be based on commands to navigate the vehicle 102 to autonomously control one or more functions of the vehicle 102 to account for the driver facial expressions derived from the determined three dimensional facial feature reconstruction.

In one or more embodiments, the vehicle autonomous controller 122 may autonomously control the operation of the vehicle 102 by providing one or more commands to one or more of the vehicle systems/control units 124 to provide full autonomous or semi-autonomous control of the vehicle 102 to follow vehicle autonomous commands provided by the application 106. Such autonomous control of the vehicle 102 may be provided by sending one or more commands to control one or more of the vehicle systems/control units 124 to operate (e.g., drive) the vehicle 102 during one or more circumstances (e.g., when providing driver assist controls), and/or to fully control driving of the vehicle 102.

The one or more commands may be provided to one or more vehicle systems/control units 124 that include, but are not limited to, a head unit, an engine control unit, a braking control unit, a transmission control unit, a steering control unit, and the like to control the output of alerts, audio, or graphics within the vehicle 102 and/or to provide autonomous driving commands based on one or more autonomous commands that are based on the driver facial expressions derived from the determined three dimensional facial feature reconstruction. For example, the one or more vehicle systems/control units 124 may provide graphical visual alerts and/or audio alerts, autonomous control, and/or semi-autonomous control to assist in navigating the vehicle 102 that may be based on driver facial expressions that may be associated with fatigue, surprise, boredom, etc. to provide alerts, audio output, graphical output, and/or autonomous control with respect to the vehicle 102.

With continued reference to FIG. 1, the camera system 114 may include cameras that may be positioned within the interior cabin of the vehicle 102. The cameras may be positioned to face one or more directions at one or more areas of the interior cabin to capture one or more images of the occupants of the vehicle 102. In some embodiments, the cameras of the camera system 114 may be disposed at portions of the vehicle 102, including, but not limited to different portions of a ceiling of the vehicle 102, vehicle side view mirrors, vehicle rear view mirror, vehicle instrument panels, vehicle dashboard, pillars within the vehicle, vehicle windshield, and the like.

As discussed above, the cameras may not be located directly in front of the individual 108 and/or the additional occupants and therefore may not necessarily capture frontal views of the individual's and/or occupants' face(s). In one or more embodiments, the images captured by respective cameras may include two dimensional images of side views of the individual's face. Accordingly, one or more cameras may capture one or more two dimensional images of a left side of the individual's face and one or more cameras may capture one or more two dimensional images of a right side of the individual's face within the vehicle 102. As discussed below, the facial reconstruction application 106 may utilize the neural network 116 to construct a three dimensional facial point cloud from multiple two-dimensional images of the individual 108 that may be captured by the cameras of the camera system 114.

With reference to FIG. 2, the external environment 200 may include a external environment 200 in which the individual 108 may be traveling. As shown, additional pedestrians 208 may also be traveling within the external environment 200. In one embodiment, the RSE 202 may include a computing system that includes a processor (not shown), a memory (not shown), and a communication unit (not shown). The RSE 202 may be associated with roadway infrastructure that may be located within the external environment 200. The roadway infrastructure may include, but may not be limited to, one or more street lights, traffic lights, road signs, and the like.

In one embodiment, the RSE 202 may be configured to execute the facial reconstruction application 106 that may be stored upon the memory of the RSE 202. In another embodiment, the RSE 202 may access the facial reconstruction application 106 through a wireless computer communication through an internet cloud (not shown). The RSE 202 may be configured to communicate via one or more communications mediums with the external server 110 through the internet cloud and/or directly through one or more wireless communications protocols to send and receive data to and from the neural network 116 that may be utilized by the facial reconstruction application 106 to construct a three dimensional facial point cloud from multiple two-dimensional images of the individual 108 that may be captured by cameras 206 of the RSE 202.

In one or more embodiments, the cameras 206 of the RSE 202 located within the external environment 200 may be configured to capture views of the individual 108 and/or one or more additional pedestrians 208 that may be traveling within the external environment 200. In some configurations, the cameras 206 may not be located directly in front of the individual 108 and/or the additional pedestrians 208 and therefore may not necessarily capture frontal views of the individual's and/or pedestrians' face(s).

In one or more embodiments, the images captured by respective cameras 206 may include two dimensional images of side views of the individual's face. Accordingly, one or more cameras 206 may capture one or more two dimensional images of a left side of the individual's face and one or more cameras 206 may capture one or more two dimensional images of a right side of the individual's face as the individual 108 is located within the external environment 200. As discussed below, the facial reconstruction application 106 may utilize the neural network 116 to construct a three dimensional facial point cloud from multiple two-dimensional images of the individual 108 that may be captured by the cameras 206 of the RSE 202.

In one embodiment, the facial reconstruction application 106 may be configured to communicate one or more commands to the RSE 202 to control one or more operations of the RSE 202. In one configuration, the RSE 202 may be controlled to operate the roadside infrastructure, such as a traffic light or digital signage in a specific manner that may be based on facial expressions of the individual 108 and/or one or more pedestrians 208 that may be derived from the determined three dimensional facial feature reconstruction completed by the facial reconstruction application 106. The image data may also be used to complete one or more downstream tasks that may take place within the external environment 200 or in additional/alternative environments.

In some embodiments, the RSE 202 may be configured to communicate via one or more communications mediums with the vehicle 102 to send and receive image data that may be utilized by the facial reconstruction application 106. For example, image data associated with one or more pedestrians 208 as captured by cameras 206 of the RSE 202 and/or one or more occupants of the vehicle 102 as captured by the cameras of the camera system 114 may be received by the facial reconstruction application 106 to determine three dimensional facial feature reconstruction of one or more occupants and/or pedestrians 208. Such information may be analyzed to derive facial expressions that may be analyzed to complete one or more downstream tasks. For example, one or more downstream tasks that may include the autonomous control of the vehicle 102 based on a pedestrian 208 that may be expressing a facial expression of shock may be provided. Additionally, one or more downstream tasks that may include controlling of a traffic light within the external environment 200 may be based on a driver expressing a facial expression that may indicate drowsiness may be provided.

With reference again to FIG. 1, the external server 110 of the system 100 may be operably controlled by the processor 112. As discussed, the memory 118 of the external server 110 may be configured to host the neural network 116. Additionally, the memory 118 may store one or more operating systems, applications, associated operating system data, application data, executable data, and the like.

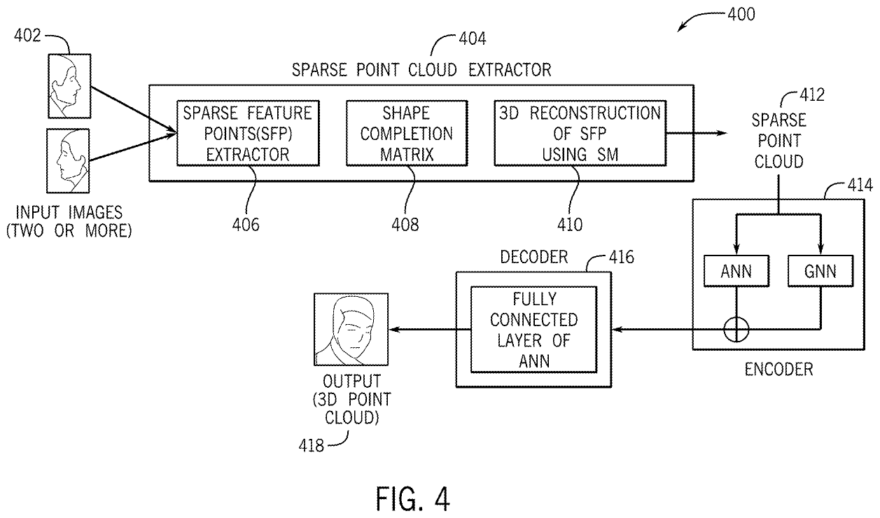

As represented in FIG. 4, the neural network 116 may include a sparse point cloud extractor 404 that is configured to create a point cloud using a fixed number of facial landmarks that define facial features that may be determined based on image data that may be associated with left and right side facial images 402 of the individual 108. The neural network 116 may be configured with an encoder-decoder architecture that may include convolutional layers that may employ graph convolutional neural networks to understand the specific geometry of an input point cloud. The encoder-decoder architecture may also include a fully connected class of feedforward artificial neural networks that may be configured to learn an overall geometry of the individual's face. As discussed below, the encoder-decoder architecture may be configured to output a three dimensional point cloud that may account for distinguishing elements of the individual's face to complete the three dimensional face reconstruction of the individual's face.

### II. The Facial Reconstruction Application and Related Methods

The components of the facial reconstruction application 106 will now be described according to an exemplary embodiment and with reference to FIG. 1. In an exemplary embodiment, the facial reconstruction application 106 may be stored on the memory 118 and executed by the processor 112 of the external server 110. In another embodiment, the facial reconstruction application 106 may additionally or alternatively be stored on the storage unit 120 of the vehicle 102 and may be executed by the ECU 104 of the vehicle 102. In an additional embodiment, the facial reconstruction application 106 may additionally or alternatively be stored on the memory of the RSE 202 and may executed by the RSE 202. The general functionality of the facial reconstruction application 106 will now be discussed.

As shown in FIG. 1, the facial reconstruction application 106 may include a plurality of modules 126-130 for completing three dimensional face reconstruction of the individual's face based on one or more two dimensional images of the left side of the individual's face and one or more two dimensional images of the right side of the individual's face. The plurality of modules 126-130 of the facial reconstruction application 106 may include a data reception module 126, a sparse point cloud module 128, and a facial point cloud module 130. However, it is to be appreciated that the facial reconstruction application 106 may include one or more additional modules and/or sub-modules that are included in addition to the modules 126-130.

As discussed in more detail below, the modules 126-130 of the facial reconstruction application 106 may provide a framework that may reconstruct a three dimensional facial feature point cloud from multiple non-overlapping images. The facial reconstruction application 106 may be configured to utilize the neural network 116 to extract two dimensional facial features from the image data associated with two dimensional images of the individual 108 and to construct a three dimensional facial feature point cloud. The facial reconstruction application 106 may also be configured to utilize the neural network 116 to complete shape completion to determine a final three dimensional facial feature point cloud which may be classified as the three dimensional face reconstruction of the individual's face that is based on the non-frontal or occluded facial images of an individual 108.

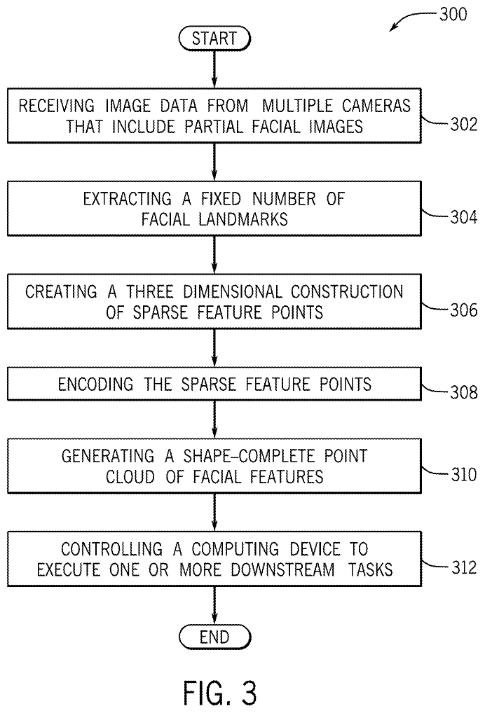

FIG. 3 is a process flow diagram of a method 300 for generating a three dimensional face reconstruction of the individual's face according to an exemplary embodiment of the present disclosure. The method 300 of FIG. 3 will be described with reference to the components of FIG. 1, FIG. 2, and FIG. 4, through it is to be appreciated that the method 300 of FIG. 3 may be used with other systems/components. The method 300 may begin at block 302, wherein the method 300 may include receiving image data from multiple cameras that include partial facial images.

In one embodiment, the data reception module 126 of the facial reconstruction application 106 may be configured to communicate with the camera system 114 of the vehicle 102 to receive image data based on two dimensional images 402 of the individuals face that may be captured by the cameras of the vehicle 102. As discussed above, the cameras may be located within interior portions of an interior cabin of the vehicle 102 and may be configured to capture views of the individual 108 and/or one or more additional occupants (not shown) of the vehicle 102.

The cameras may not be located directly in front of the individual 108 and/or the additional occupants and therefore may not necessarily capture frontal views of the individual's and/or occupants' face(s). In one or more embodiments, the two dimensional images 402 captured by respective cameras may include images of side views of the individual's face. Accordingly, one or more cameras may capture one or more two dimensional images 402 of the left side of the individual's face and one or more cameras may capture one or more two dimensional images 402 of the right side of the individual's face within the vehicle 102. Such images may be communicated as image data that may be associated with the two dimensional images 402 of the different sides of the individual's face to the data reception module 126. In particular, the two dimensional images 402 may be non-frontal facial images which may include side images of the individual's face that may contain self-occlusions that may be due to the individual 108 and/or one or more objects.

In another embodiment, the data reception module 126 of the facial reconstruction application 106 may be configured to communicate with the RSE 202 to receive image data based on two dimensional images 402 of the individuals face that may be captured by the cameras 206 of one or more RSE 202. As discussed above, the cameras 206 may be disposed upon each RSE 202 and may be configured to capture views of the individual 108 and/or pedestrians 204 that may be traveling within the external environment 200.

The cameras may not be located directly in front of the individual 108 and/or the pedestrians 204 and therefore may not necessarily capture frontal views of the faces of the individual 108 and/or the pedestrians 208. The images captured by respective cameras may include two dimensional images 402 of a side view of the individual's face. Accordingly, one or more cameras 206 may capture one or more two dimensional images 402 of a left side of the individual's face and one or more cameras 206 may capture one or more two dimensional images 402 of a right side of the individual's face as they are traveling within the external environment 200. Such images may be communicated as image data that may be associated with the two dimensional images 402 of the different sides of the individual's face to the data reception module 126.

In an exemplary embodiment, upon receiving the image data, the data reception module 126 may communicate the image data to a sparse point cloud module 128 of the facial reconstruction application 106. As discussed in more detail below, the sparse point cloud module 128 may be configured to utilize the neural network 116 to extract two dimensional facial features from the image data and determine sparse three dimensional facial feature point clouds 412 that may be associated with different portions of the individual's face.

With continued reference to FIG. 3 and FIG. 4, the method 300 may proceed to block 304, wherein the method 300 may include extracting a fixed number of facial landmarks. In an exemplary embodiment, the sparse point cloud module 128 of the facial reconstruction application 106 may be configured to pass the image data that is associated with the two dimensional images 402 of the different sides of the individual's face to the sparse point cloud extractor 404 of the neural network 116. In one embodiment, a sparse feature points extractor 406 of the sparse point cloud extractor 404 may execute machine learning/deep learning instructions and/or techniques to identify and extract a fixed number of facial landmarks. Such facial landmarks may include two dimensional coordinates of a point located on facial features of the individual's face. These points may include, but may not be limited to, a nose tip, a left corner of a lip, a right corner of a lip, a left cheek, a right cheek, a chin, etc.

The method 300 may proceed to block 306, wherein the method 300 may include creating a three dimensional construction of sparse feature points. In an exemplary embodiment, the locations of the facial landmarks (extracted at block 304) may not be accurate due to self-occlusions. To remedy this issue, the sparse point cloud module 128 of the facial reconstruction application 106 may utilize a shape completion matrix 408 of the sparse point cloud extractor 404 to estimate true locations of the self-occluded facial feature points that may pertain to one or more distinguishing elements of the individual's face, such as an eye, nose, lips, etc. that may have been occluded within one or more of the two dimensional images 402.

In one embodiment, upon estimating the true locations of the self-occluded facial feature points, the sparse point cloud extractor 404 may complete a three dimensional reconstruction 410 of spare feature points as determined by the sparse point cloud extractor 404 using the shape completion matrix 408. In one embodiment, the sparse point cloud extractor 404 may complete the three dimensional reconstruction 410 by creating a three dimensional construction of the sparse feature points using a shape conversion motion algorithm for pattern recognition. The sparse point cloud extractor 404 may thereby be configured to output sparse three dimensional facial feature point clouds 412 associated with portions of the individual's face. The sparse three dimensional facial feature point clouds 412 may include image point clouds that has been created using a fixed number of facial landmarks defining facial features that are used to match the corresponding features in the two dimensional images 402. In an exemplary embodiment, the sparse point cloud module 128 may communicate data associated with the sparse three dimensional facial feature point clouds 412 to the facial point cloud module 130 of the facial reconstruction application 106.

The method 300 may proceed to block 308, wherein the method 300 may include encoding the sparse feature points. In an exemplary embodiment, the facial point cloud module 130 of the facial reconstruction application 106 may be configured to input data associated with the sparse three dimensional facial feature point clouds 412 to an encoder 414 of the encoder-decoder architecture of the neural network 116. The data may be associated with the sparse point clouds with variable number of points which are fed into the encoder 414. In one embodiment, the encoder 414 may employ graph convolutional neural networks to understand a specific geometry of the input point cloud and a fully connected class of artificial neural networks learn an overall geometry of the individual's face. In one configuration, the encoder 414 is configured to encode the node features along with the information of neighbors of the respective node features to make optimum use of both local and global information. The encoder 414 may be configured to output the encoded node features as an output vector.

The method 300 may proceed to block 310, wherein the method 300 may include generating a shape-complete point cloud of facial features. In an exemplary embodiment, the facial point cloud module 130 of the facial reconstruction application 106 may be configured to input the output vector output by the encoder 414 into a decoder 416 of the encoder-decoder architecture of the neural network 116. In an exemplary embodiment, the decoder 416 may include a fully connected layer of the artificial neural network. The decoder 416 may be configured to decode the sparse three dimensional facial feature point clouds 412 and may thereby generate a shape-completed three dimensional facial feature point cloud 418 of the facial features of the individual 108. The three dimensional facial feature point cloud 418 may be communicated to the facial point cloud module 130. The facial point cloud module 130 may thereby classify the three dimensional facial feature point cloud 418 as the three dimensional face reconstruction of the individual's face that is based on the non-frontal or occluded facial images of an individual 108.

The method 300 may proceed to block 312, wherein the method 300 may include controlling a computing device to execute one or more downstream tasks. In an exemplary embodiment, the facial point cloud module 130 may be configured to analyze the three dimensional face reconstruction of the individual's face for a variety of applications such as human emotion estimation (anger, disgust, feat, happiness, sadness, surprise, neutral, etc.), human satisfaction level estimation (for example, range 1-10, 1 being the lowest and 10 being the highest), relational affect estimation (positive, negative, neutral, etc.), etc.

In one configuration, the facial point cloud module 130 of facial reconstruction application 106 may be configured to communicate one or more commands to the vehicle autonomous controller 122 to output commands to one or more of the vehicle systems/control units 124 to control the vehicle systems/control units 124 to provide alerts, audio output, or graphical output within the vehicle 102 that may be based on driver facial expressions derived from the determined three dimensional facial feature reconstruction of the individual's face. In another configuration, the facial point cloud module 130 of facial reconstruction application 106 may be configured to communicate one or more commands to the RSE 202 to control one or more operations of the RSE 202.

In one configuration, the RSE 202 may be controlled to operate the roadside infrastructure, such as a traffic light or digital signage in a specific manner that may be based on facial expressions of the individual 108 derived from the determined three dimensional facial feature reconstruction completed by the facial reconstruction application 106. However, it is to be appreciated that the facial point cloud module 130 of facial reconstruction application 106 may be configured to communicate one or more commands to additional types of computing systems (not shown) to complete one or more downstream tasks that may take place additional/alternative environments.

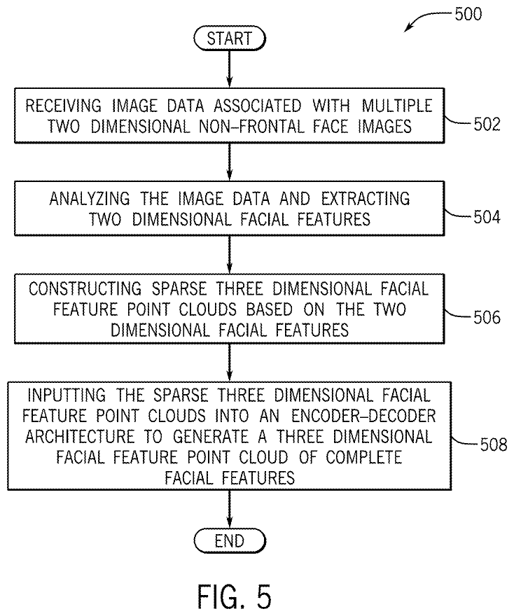

FIG. 5 is a process flow diagram of a method 500 for completing three dimensional face reconstruction according to an exemplary embodiment of the present disclosure. The method 500 of FIG. 5 will be described with reference to the components of FIG. 1, FIG. 2, and FIG. 4, through it is to be appreciated that the method 500 of FIG. 5 may be used with other systems/components. The method 500 may begin at block 502, wherein the method 500 may include receiving image data associated with multiple two dimensional non-frontal face images.

The method 500 may proceed to block 504, wherein the method 500 may include analyzing the image data and extracting two dimensional facial features. The method 500 may proceed to block 506, wherein the method 500 may include constructing sparse three dimensional facial feature point clouds 412 based on the two dimensional facial features. The method 500 may proceed to block 508, wherein the method 500 may include inputting the sparse three dimensional facial feature point clouds into an encoder-decoder architecture to generate a three dimensional facial feature point cloud 418 of complete facial features. In one embodiment, the three dimensional facial feature point cloud 418 is utilized to control a computing device to complete a downstream task.

It should be apparent from the foregoing description that various exemplary embodiments of the disclosure may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for completing three dimensional face reconstruction comprising:
receiving image data associated with multiple two dimensional non-frontal face images;
analyzing the image data and extracting two dimensional facial features;
constructing sparse three dimensional facial feature point clouds based on the two dimensional facial features; and
inputting the sparse three dimensional facial feature point clouds into an encoder-decoder architecture to generate a three dimensional facial feature point cloud of complete facial features, wherein the three dimensional facial feature point cloud is utilized to control a computing device to complete a downstream task.

2. The computer-implemented method of claim 1, wherein the multiple two dimensional non-frontal face images include occlusions that are caused by at least one of: an individual who is being captured within the images and an object that is located in between at least one camera and the individual who is being captured within the images.

3. The computer-implemented method of claim 2, wherein analyzing the image data includes extracting a fixed number of facial landmarks, wherein the fixed number of facial landmarks include the occlusions and a shape completion matrix is used to estimate true locations of occluded facial feature points.

4. The computer-implemented method of claim 3, wherein facial features that correspond to the facial landmarks in the multiple two dimensional non-frontal face images are matched.

5. The computer-implemented method of claim 4, wherein constructing the sparse three dimensional facial feature point clouds includes using the matching correspondences of the facial features to the facial landmarks in the multiple two dimensional non-frontal face images to create a three dimensional reconstruction of sparse feature points.

6. The computer-implemented method of claim 5, wherein inputting the sparse three dimensional facial feature point clouds into the encoder-decoder architecture include inputting the sparse three dimensional facial feature point clouds with a variable number of points to generate a complete dense point cloud of a missing part of the face of the individual who is being captured within the images.

7. The computer-implemented method of claim 6, wherein an encoder of the encoder-decoder architecture employs graph convolutional neural networks to understand a specific geometry of the sparse three dimensional facial feature point clouds and uses a fully connected class of feedforward artificial neural networks to learn an overall geometry of the face of the individual who is being captured within the images.

8. The computer-implemented method of claim 7, wherein the encoder encodes node features along with information of neighbor nodes to use both local and global information to learn an overall geometry of the face of the individual who is being captured within the images.

9. The computer-implemented method of claim 8, wherein an output vector of the encoder is fed into a decoder of the encoder-decoder architecture to decode sparse three dimensional facial feature point clouds and to generate the three dimensional facial feature point cloud of complete facial features.

10. A system for completing three dimensional face reconstruction comprising:
a memory storing instructions when executed by a processor cause the processor to:
receive image data associated with multiple two dimensional non-frontal face images;
analyze the image data and extracting two dimensional facial features;
construct sparse three dimensional facial feature point clouds based on the two dimensional facial features; and
input the sparse three dimensional facial feature point clouds into an encoder-decoder architecture to generate a three dimensional facial feature point cloud of complete facial features, wherein the three dimensional facial feature point cloud is utilized to control a computing device to complete a downstream task.

11. The system of claim 10, wherein the multiple two dimensional non-frontal face images include occlusions that are caused by at least one of: an individual who is being captured within the images and an object that is located in between at least one camera and the individual who is being captured within the images.

12. The system of claim 11, wherein analyzing the image data includes extracting a fixed number of facial landmarks, wherein the fixed number of facial landmarks include the occlusions and a shape completion matrix is used to estimate true locations of occluded facial feature points.

13. The system of claim 12, wherein facial features that correspond to the facial landmarks in the multiple two dimensional non-frontal face images are matched.

14. The system of claim 13, wherein constructing the sparse three dimensional facial feature point clouds includes using the matching correspondences of the facial features to the facial landmarks in the multiple two dimensional non-frontal face images to create a three dimensional reconstruction of sparse feature points.

15. The system of claim 14, wherein inputting the sparse three dimensional facial feature point clouds into the encoder-decoder architecture include inputting the sparse three dimensional facial feature point clouds with a variable number of points to generate a complete dense point cloud of a missing part of the face of the individual who is being captured within the images.

16. The system of claim 15, wherein an encoder of the encoder-decoder architecture employs graph convolutional neural networks to understand a specific geometry of the sparse three dimensional facial feature point clouds and uses a fully connected class of feedforward artificial neural networks to learn an overall geometry of the face of the individual who is being captured within the images.

17. The system of claim 16, wherein the encoder encodes node features along with information of neighbor nodes to use both local and global information to learn an overall geometry of the face of the individual who is being captured within the images.

18. The system of claim 17, wherein an output vector of the encoder is fed into a decoder of the encoder-decoder architecture to decode sparse three dimensional facial feature point clouds and to generate the three dimensional facial feature point cloud of complete facial features.

19. A non-transitory computer readable storage medium storing instructions that when executed by a computer, which includes a processor performs a method, the method comprising:
receiving image data associated with multiple two dimensional non-frontal face images;
analyzing the image data and extracting two dimensional facial features;
constructing sparse three dimensional facial feature point clouds based on the two dimensional facial features; and
inputting the sparse three dimensional facial feature point clouds into an encoder-decoder architecture to generate a three dimensional facial feature point cloud of complete facial features, wherein the three dimensional facial feature point cloud is utilized to control a computing device to complete a downstream task.

20. The non-transitory computer readable storage medium of claim 19, wherein an output vector of an encoder is fed into a decoder of the encoder-decoder architecture to decode sparse three dimensional facial feature point clouds and to generate the three dimensional facial feature point cloud of complete facial features.
